(19) United States
(12) Patent Application Publication
(10) Pub. No.: US 2006/0293420 A1
(43) Pub. Date: Dec. 28, 2006

(54) Composition comprising asphalt, ethylene copolymer, and sulfur

(76) Inventors: George Wyatt Prejean, Orange, TX (US); Gregg Byron Babcock, Wilmington, DE (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/472,735

(22) Filed: Jun. 22, 2006

Related U.S. Application Data
(60) Provisional application No. 60/693,399, filed on Jun. 23, 2005.

(51) Int. Cl. C08L 95/00

(52) U.S. Cl. 524/59; 524/418

(57) ABSTRACT

A composition and a process for producing the composition are disclosed. The composition comprises or is produced from asphalt, an ethylene copolymer, a sulfur source, and optionally a polymer comprising repeat units derived from styrene and butadiene. The process comprises contacting a sulfur source with a mixture, which comprises asphalt, an ethylene copolymer, and optionally a polymer comprising repeat units derived from styrene and butadiene.

The application claims priority to U.S. provisional application No. 60/693399, filed Jun. 23, 2005, the entire disclosure of which is incorporated herein by reference.

The invention relates to a composition comprising or produced from asphalt, an ethylene copolymer, sulfur, and optionally a SB polymer, SBS polymer, or both; to a process therefor; and to a process therewith.

### BACKGROUND OF THE INVENTION

Commercial asphalt for paving can be modified with a polymer to improve resistance to rut, fatigue, cracking, and stripping (from aggregate) because of possible increases in asphalt elasticity and stiffness. Asphalts are performance-graded (PG) by a set of specifications developed by the United States federal government (Strategic Highway Research Program or SHRP). For example, PG58-34 asphalt can provide good rut resistance at 58° C. (upper PG value; determined by AASHTO (American Association of State Highway Transportation Officials) test TP5 and good cold cracking resistance at −34° C. (lower PG value; determined by ASSHTO test TP1). Addition of polymer to asphalt provides higher temperature rut resistance and improves fatigue resistance. The asphalt industry considers polymers for asphalt modification to be either elastomers or plastomers. The word plastomer has a negative connotation in the asphalt industry and indicates a lack of elastomeric properties. Plastomers are sometimes used to modify asphalt because they can increase stiffness and viscosity which improves rut resistance but they may be inferior to elastomers due to lack of improvements in fatigue resistance, creep resistance, cold crack resistance, etc. One good indication that a polymer is acting like an elastomer is a reduced phase angle (phase angle for a Newtonian liquid is 90 degrees and phase angle for a perfect elastic solid is 0 degrees). The phase angle for unmodified asphalt is variable but is generally in the range of 80 to 86 degrees. Elastomers reduce the phase angle to a range of 55 to 75 degrees. Plastomers reduce the phase angle to the range of 75 to 80 degrees.

SBS (styrene-butadiene-styrene) block copolymers and SB (styrene-butadiene) random copolymers can be used for asphalt modification. SBS block copolymers currently dominate the polymer modified asphalt market. SB/SBS are normally added to asphalt at the 3% to 6% level and in many cases sulfur is added to partially crosslink the SB/SBS (through the unsaturation) to improve performance. Block SBS and random SB are difficult to dissolve in asphalt and require high shear mixing mills.

An ethylene copolymer such as terpolymer comprising repeat units derived from ethylene, butyl acrylate, and glycidyl methacrylate (ENBAGMA) has been used for asphalt modification (e.g., U.S. Pat. No. 5,306,750). ENBAGMA is commercially available from E. I. du Pont de Nemours and Company, Wilmington, Del. (DuPont) under the trademark of Elvaloy® and can impart elastomeric properties after it reacts with asphalt. Elvaloy® is normally added to asphalt at the 0.7% to 2% level. The improvement in asphalt properties with addition of Elvaloy® at such concentrations is believed due to a chemical reaction between the Elvaloy® and the functionalized polar fraction of asphalt referred to as asphaltenes. Superphosphoric acid (SPA) is often used to enhance the reaction between Elvaloy® and the asphaltene fraction of asphalt (e.g., U.S. Pat. Nos. 6,117,926 and 6,399,680). Elvaloy® also heat reacts with the asphaltenes in asphalt without the SPA catalyst but the reaction takes longer and the resultant PMA is not as elastic (as evidenced by a higher phase angle). The mixing time is 6-24 hours in the absence of SPA and 3-6 hours in the presence of SPA.

ENBAGMA can be used in conjunction with block SB or SBS for asphalt modification to reduce the amount of SB or SBS incorporated (Elvaloy® in combination with SB random copolymers for asphalt modification is not covered by a patent) thereby increasing the capacity of PMA (polymer modified asphalt) plants modifying with block SBS or block SB with Elvaloy®.

### SUMMARY OF THE INVENTION

A composition comprises asphalt, an ethylene copolymer, a sulfur source, and optionally a polymer comprising repeat units derived from styrene and butadiene.

A process comprises contacting a sulfur source with a mixture, which comprises asphalt, an ethylene copolymer, and optionally a polymer comprising repeat units derived from styrene and butadiene.

### DETAILED DESCRIPTION OF THE INVENTION

Asphalt can be obtained as a residue in the distillation or refining of petroleum or can be naturally occurring, as is the case with Trinidad Lake asphalt. Chemically it is a complex mixture of hydrocarbons which can be separated into two major fractions —asphaltenes and maltenes. The asphaltenes are polycyclic aromatics and most contain functionality (some or all of the following functionalities are present; carboxylic acids, amines, sulfides, sulfoxides, sulfones, sulfonic acids, porphrin rings chelated with V, Ni and Fe). The maltenes phase contains polar aromatics, aromatics, naphthene. It is generally believed that asphalt is a colloidal dispersion with the asphaltenes dispersed in the maltenes; the dispersing agent being the polar aromatics. The asphaltenes are relatively high in molecular weight (about 1500) as compared with the other components of asphalt. The asphaltenes are amphoteric (acid and base on same molecule) in nature and form aggregates through self-association that offer some viscoelastic behavior to asphalt. Asphaltenes vary in amount and functionality depending on the crude source from which the asphalt is derived.

All asphalts containing asphaltenes can be used. The asphalt can be of low or high asphaltene content. The asphaltene content can be from about 0.01 to about 30, about 0.1 to about 15, about 1 to about 10, or about 1 to about 5%, by weight. Examples of asphalts include Wyoming Sour, Mayan, Venezuelan, Canadian, Arabian, Trinidad Lake, and combinations of two or more thereof.

Asphalts can be diluted with flux oils (e.g., Hydrolene®flux oil) to obtain about 100 to about 350 or about 200 to about 300 pen asphalts and to improve low temperature properties (e.g., preventing low temperature cracking) for pavements in cold climates. Flux oils can encompass many types of oils used to modify asphalt and are the final products in crude oil distillation. They are non-volatile oils that are blended with asphalt to soften it. They can be aromatic, paraffinic or naphthenic (e.g., Sonoco offers 19 different flux oils under the tradename Hydrolene®). Pen (short for penetration) is one means of characterizing asphalts. High pen grades are soft asphalts (e.g., 300 pen is a very soft asphalt). Normally pen is determined at 25° C. by ASTM D5. It is the distance in tenths of one mm that a needle under a load of 100 grams penetrates the asphalt in 5 seconds. Under these circumstances, the asphaltene concentration in the composition can range from about 0.0001 to about 1 wt % or higher such that the asphalt can react the acid in the ethylene copolymer but may not react with either acids such as superphosphoric acid (SPA) catalyst or heat (see, e.g., U.S. Pat. No. 6,117,926).

A modified asphalt may also be used. For example, a sulfonated asphalt or salt thereof (e.g., sodium salt), an oxidized asphalt, or combinations thereof may be used in combination of the asphalt disclosed above.

The polymer comprising repeat units derived from styrene can be any known polymer comprising repeat units derived from styrene and a diene such as SBS block copolymer. The “B” segment of the SBS block polymer is a diene polysegment which can be a conjugated diene having 4-6 carbons atoms such as 1,3-butadiene, isoprene, 2-ethyl-1,3-butadiene, 2,3-dimethyl-1,3-butadiene and piperylene. The “S” segment of the block copolymer is a monovinyl aromatic polysegment. Examples of such are styrene, α-methylstyrene, p-vinyltoluene, m-vinyltoluene, o-vinyltoluene, 4-ethylstyrene, 3-ethylstyrene, 2-ethylstyrene, 4-tert-butylstyrene and 2,4-dimethylstyrene. SBS block copolymer is a tri-block polymer having a polystyrene segment at the ends of the molecule and an elastomeric segment—a conjugated diene in the center of the block polymer. For paving application, the wt % range of polystyrene may range from about 10 to about 50 or about 20 to 40%. SBS copolymers are available commercially from, e.g., Kraton Polymers (Houston, Tex. USA), Enichem (Houston, Tex. USA), and ConocoPhillips (Houston, Tex. USA).

SB is a random copolymer (also known as SBR) comprising repeat units derived from styrene and butadiene in which styrene and butadiene are randomly dispersed in the polymer molecule.

SB and SBS can be made by anionic polymerization. For example, random SB can be made in a solution process. The details of the process for production can be found for example in a Nexant ChemSystems Report published Dec. 3, 2003 (Nexant is in San Francisco, Calif., USA). Both SBS block copolymer and SB random copolymer are commercially available from, e.g., Dutch State Mines, Netherlands (DSM), Sartomer (Exton, Pa., USA) and Goodyear (Akron, Ohio, USA). Diblock SB can also be used in this invention. Preferred wt % polystyrene range is the same as for SBS.

These diblock and triblock copolymers based on styrene and butadiene can be prepared by conventional procedures such as those described in U.S. Pat. No. 3,281,383 and U.S. Pat. No. 3,639,521.

Ethylene copolymer can comprise repeat units derived from ethylene and an ester of unsaturated carboxylic acid such as (meth)acrylate or C₁ to C₈ alkyl (meth)acrylate, or combinations of two or more thereof. “(Meth)acrylate”, refers to acrylate, alkyl acrylate, methacrylate, or combinations of two or more thereof.

Examples of alkyl acrylates include methyl acrylate, ethyl acrylate and butyl acrylate. For example, “ethylene/methyl acrylate (EMA)” means a copolymer of ethylene and methyl acrylate (MA); “ethylene/ethyl acrylate (EEA)” means a copolymer of ethylene and ethyl acrylate (EA); “ethylene/butyl acrylate (EBA)” means a copolymer of ethylene and butyl acrylate (BA); and includes both n-butyl acrylate and iso-butyl acrylate; and combinations of two or more thereof.

Copolymers of ethylene and an acrylate are well known. “Ethylene acrylate copolymers” may also be referred to as ethylene-acrylic acid ester copolymers. They can be manufactured from two high-pressure free radical processes: tubular processes or autoclave processes. The difference in ethylene acrylate copolymers made from the two processes is described in, e.g., “High flexibility EMA made from high pressure tubular process.” Annual Technical Conference—Society of Plastics Engineers (2002), 60th (Vol. 2), 1832-1836. The ethylene acrylate copolymer produced from the tubular process is preferred in the invention herein.

Alkyl (meth)acrylate comonomer incorporated into ethylene copolymer can vary from 0.01 or 5 up to as high as 40 weight % of the total copolymer or even higher such as from 5 to 30, or 10 to 25, wt %.

Ethylene copolymer can also include another comonomer such as carbon monoxide, glycidyl acrylate, glycidyl methacrylate, and glycidyl vinyl ether, (meth)acrylic acid, vinyl acetate, or combinations of two or more thereof.

The ethylene copolymer may contain 0 or about 15 to about 40, or about 18 to about 35, wt % of acrylate comonomer. Increasing acrylate comonomer may improve the elastomeric properties and increase the tackiness of the copolymer. The ethylene copolymer may have a melt index (MI) of from about 0.1 to about 1000, about 0.1 to about 1000, or about 0.5 to about 20, g/10 min, measured with ASTM D-1238, condition E (190° C., 2160 gram weight).

An ethylene copolymer can also be represented as an E/X/Y copolymer derived by copolymerization of the monomer units E, X and Y in random order where E is derived from ethylene. X is derived from one or more C₁ to C₈ alkyl acrylates disclosed above such as n-butyl acrylate (nBA) or methacrylate, or a vinyl acetate, or combinations of two or more thereof. X can be present in the ethylene copolymer from about 0, 1, 5, or 8 to about 70 wt %, or about 0, 1, 5, or 8 to about 45 wt %. The X component may also be selected from moiety in the same wt range. Y is another comonomer such as, for example, a glycidyl esters of acrylic acid or methacrylic acid, glycidyl vinyl ether, or combinations thereof can be a Y comonomer and may be incorporated into the ethylene copolymer from about 0.5 to about 16% or about 5% to about 12%. E is the remainder. For example, a frequently used E/X/Y copolymer is E/nBA/GMA comprising units derived from ethylene, nBA, and glycidyl methacrylate. The E/X/Y copolymers can be produced by well known methods using a continuous reactor at high temperatures and pressures such as disclosed in U.S. Pat. Nos. 4,351,931 and 3,780,140. See also U.S. Pat. No. 6,716,920.

Sulfur source can be element sulfur, a sulfur donor, a sulfur byproduct, or combinations of two or more thereof. A sulfur donor generates sulfur in-situ when included in the composition. Examples of sulfur donors include sodium diethyldithiocarbamate, 2,2-dithiobis(benzothiazole), mercaptobenzothiazole, dipentamethylenethiuram tetrasulfide, or combinations of two or more thereof and include Sasobit® TXS (a proprietary product available from Sasol Wax Americas, Shelton, Conn., USA). A sulfur byproduct can include one or more sulfonic acids, sulfides, sulfoxides, sulfones, or combinations of two or more thereof.

The composition can comprise or be produced from about 0.01 to about 10 wt %, or about 0.1 to about 5 wt %, or about 0.5 to about 2 wt % of one or more ethylene copolymers; about 0.001 to about 5 wt %, or about 0.005 to about 2 wt %, or about 0.01 to about 0.5 wt % of sulfur or sulfur donor or sulfur byproduct (based on the available sulfur content); and the remainder is the asphalt.

If a copolymer comprising units derived from styrene and butadiene is employed, the copolymer can be present in the composition in the range from about 0.01 to about 10 wt %, or about 0.1 to about 5 wt %, or about 0.5 to about 2 wt %.

The composition can be produced by, for example, contacting sulfur with a mixture comprising the asphalt, ethylene copolymer, and optionally the polymer derived from styrene and butadiene. Sulfur can also be combined with asphalt before the ethylene copolymer and optional polymer are combined with the asphalt. Asphalt can be heated to a range of about 150 to about 250° C., or about 170 to 225° C., or to molten stage in any suitable vessel such as a mixing tank or a reactor or a metal can. An aromatic flux oil disclosed above can also be added to the asphalt to produce a softer asphalt. The ethylene copolymer and the optional copolymer derived from styrene and butadiene, in any physical form such as pellets, can be added to the molten asphalt to produce a molten mixture. Sulfur or sulfur donor can also be combined with the molten mixture.

The molten mixture comprising sulfur of sulfur donor can be heated at about 150 to about 250° C., or about 170 to 225° C. under a pressure that can accommodate the temperature range, such as atmospheric pressure, for about 1 to about 35 hours, or about 2 to about 30 hours, or about 5 to about 25 hours.

The molten mixture can be mixed by, for example, a mechanical agitator or any other mixing means.

PMAs are normally produced in a high sheer mill process, or in a low sheer mixing process, as is well known to one skilled in the art. For example, process used is dependant on the equipment available, and on the polymers used. Polymers that can be used in low sheer mixing equipment can be used in high sheer equipment also. Either type of equipment can be used with this invention. A solvent may or may not be used to disperse polymers that are typically used in high sheer equipment into asphalt by using low sheer equipment. A good example on how PMA can be produced commercially can be found in publications IS-200, from the Asphalt Institute, Lexington, Ky.

Wishing not to be bound by theory, it is believed that an ethylene copolymer such as E/nBA/GMA reacts with carboxylic acid groups in asphaltenes to obtain efficacy as an asphalt modifier, either catalyzed by SPA or heat. This reaction may depend both on asphaltene content of the asphalt and on asphaltene functionality (i.e., how many carboxylic acid groups present). Normal asphaltene levels are in the 15% to 30% range. At this level ENBAGMA readily reacts. The asphalts can contain much lower asphaltene content, possibly due to dilution with soft materials, and may be from about 0.01 to about 30, about 0.1 to about 15, about 1 to about 10, or about 1 to about 5%, by weight.

This invention can be used anytime an elastomeric modification of asphalt is desired. This modified asphalt composition can be mixed with aggregates at a ratio of about 1 to about 10 or about 5% asphalt, about 90 to about 99 or about 95% aggregates and used for paving. Polymer-modified asphalts can be used for paving of highways, city streets, parking lots, ports, airfields, sidewalks, and many more. Polymer-modified asphalts can also be used as a chip seal, emulsions, or other repair product for paved surfaces.

The asphalt composition disclosed here can also be used as a roofing or waterproofing product. Highly modified asphalt can be used to adhere various roofing sheets to roofs or used as a waterproofing covering for many roofing fabrics. The modified asphalt can then be used in paving applications, or in roofing applications, or in any other application using an elastomeric modified asphalt such as pipe coasting or other industrial protection coatings (e.g., concrete, steel, etc.).

### EXAMPLES

### Example 1

A mixture containing 500 grams of a low asphaltene PG 54-34 asphalt obtained from Sinclair, (Sinclair, Wyo., USA) was placed in an 1000 ml metal can, and heated to 400° F. (about 205° C.) for one hour. A high sheer mixer was placed into the asphalt. 1.5% of a random SB polymer obtained from Dutch State Mines (Baton Rouge La.) type 2029 was added. Following the addition of the SB, 0.08 wt % of sulfur was added to the mixture. The can of PMA was kept at 400° F. for 1 hour. Then 1.2 wt % Elvaloy® 4170 was added to the PMA (again utilizing the high sheer mixer), and was heated for 3 hours with mixing at 300 rpm using a 3 blade paddle mixer. All weight % was based on final total weight of the mixture. The PMA was then tested per AAHSTO TP5 and AAHSTO TP1 and passed a PG 64-34 specification.

After heating and stirring the asphalt with a three blade paddle stirrer at 300 rpm for 12 hours in the 1000 ml metal can at ˜400° F. at atmospheric pressure, the resultant PMA was a PG64-34 (the desired grade).

### Comparative Example 1

An asphalt PMA (500 g) containing 4 wt % random SB and 0.02 wt % sulfur was prepared by heating for 12 hours at ˜400° F. in an 1000 ml metal can. The asphalt was the same low asphaltene asphalt as disclosed in Example 1 above. The SB PMA was heated for 12 hours at 400° F. in an 1000 ml metal can (stirred at 300 rpm with a 3 blade paddle mixer) for cross linking to occur with sulfur. This PMA met the desired PG 64-34 grade, but was un-economical versus Example 1 due to the high level of SB required.

Another PMA (500 g) containing 2.0 wt % Elvaloy® 4170 was prepared at the same time. The asphalt used was again the low asphaltene content asphalt (PG54-35). The intent was to prepare a PG 64-34 from the 2% Elvaloy® 4170 PMA after heating for 24 hours and then blend the two PMA's to produce a more economical asphalt. However no increase in upper PG occurred (AASHTO TP5 test) for the 2% Elvaloy® 4170 PMA after heating for 24 hours at 400° F. in an 1000 ml metal can (stirred at 300 rpm with a three blade paddle mixer). 100 parts of the random 4% SB PMA was then blended with 167 parts of the unreacted 2% Elvaloy® 4170 PMA to produce a PMA with 1.5 wt % SB, 1.2 wt % Elvaloy® 4170 and 0.0075 wt % sulfur and the resultant PMA was again heated in an 1000 ml metal can and stirred with a three blade paddle mixer for 24 hours at 400° F. It was hoped that the Elvaloy® 4170 would react with this second 24 heating and produce an overall PG value of 64-34. However the desired PG value was still not obtained.

### Example 2

A PG 58-28 asphalt (Ultramar Canada, St Romauld, Canada) was modified with 1.5 wt % Elvaloy® 4170 and 0.1 wt % sulfur. The PMA was heated in an 1000 ml metal can at 400° F. and stirred for 5 hours with a three-blade paddle mixer at 300 rpm. The PG pass/fail and phase angle (according to ASSHTO TP5 test) were determined every hour. Results are shown in Table 1.

### Comparative Example 2

The same PG 58-28 asphalt as used in Example 2 was modified with 1.5 wt % Elvaloy® 4170 and no sulfur. The PMA was heated at 400° F. and stirred for 6 hours. The PG grade, PG pass/fail and phase angle were determined every hour. Results are shown in Table 1.

In Table 1, PG grade (upper) was determined by measuring G*/sin d with a dynamic shear rheometer. G* is the complex modulus and d is the phase angle. PG grades ran from 46° C. to 82° C. in 6 degree increments. PG grades of 52, 58, 64 and 76 were most commonly used. A PG grade was defined when G*/sin d equals 1. For example if G*/sin d equaled 1 at 58° C. then the PG grade was 58. The value of d (phase angle) was also normally reported (an indication of how elastic the asphalt was). The pass/fail temperature was the exact temperature where G*/sin d equaled 1. For example, a PG 58 asphalt might have a pass/fail temperature of 60.5. It was still considered a PG 58 since PG ratings went in 6° C. increments (a pass/fail temperature anywhere between 58° C. and 64° C. still represented a PG 58). The pass/fail temperature indicated whether it was a “strong” PG grade (for example a PG 58 asphalt with a pass/fail temperature of 62 was a very strong PG 58). The dynamic shear rheometer imparted a sinusoidal strain to the asphalt sample at 1.59 cycles/sec. (representative of 55 mph). The elastic and viscous component of the material was determined from which G* and d were determined (MSHTO TP5 test).

TABLE 1

| | | G*/sin d | | |
|---|---|---|---|---|
| | Mix | (original) | G*/sin d (original) | Phase Angle° |
| Sulfur¹ | Time² | PG Grade | Pass/Fail = 1.0 Mpa | (original) |
| no | 0 | 58 | 60.2 | 84 |
| no | 1 | 64 | 65 | 76 |
| no | 2 | 64 | 64.9 | 74.5 |
| no | 3 | 64 | 68 | 72.6 |
| no | 4 | 64 | 69.4 | 71.3 |
| no | 5 | 64 | 68.5 | 71 |
| no | 6 | 64 | 68.7 | 70.1 |
| 0.01 wt % | 0 | 58 | 60.2 | 84 |
| 0.01 wt % | 1 | na³ | na | na |
| 0.01 wt % | 2 | 70 | 70 | 71.8 |
| 0.01 wt % | 3 | 70 | 70.1 | 70.9 |
| 0.01 wt % | 4 | 70 | 73 | 69.2 |
| 0.01 wt % | 5 | 70 | 71.2 | 68.8 |

¹Polymer used was Elvaloy ® 4170 (containing 25% nBA and 9% GMA) obtained from E. I. du Pont de Nemours and Company, Wilmington, Delaware.
²(Hours at 400° F.)
³na denotes Not available

1. A composition comprising or produced from asphalt, an ethylene copolymer, a sulfur source, and an optional copolymer comprising repeat units derived from styrene and butadiene wherein the ethylene copolymer comprises units derived from ethylene, alkyl (meth)acrylate, and an optional comonomer; the sulfur source is elemental sulfur, a sulfur donor, a sulfur byproduct, or combinations of two or more thereof; the optional copolymer comprises repeat units derived from styrene and butadiene; and the optional comonomer is carbon monoxide, glycidyl acrylate, glycidyl methacrylate, and glycidyl vinyl ether, or combinations of two or more thereof.

2. The composition of claim 1 comprising the optional copolymer and the ethylene copolymer comprises units derived from the optional comonomer and the ethylene copolymer comprises units derived from the optional comonomer.

3. The composition of claim 2 wherein the sulfur source is sulfur, sodium diethyldithiocarbamate, 2,2-dithiobis(benzothiazole), mercaptobenzothiazole, dipentamethylenethiuram tetrasulfide, a sulfonic acid, a sulfide, a sulfoxide, a sulfone, or combinations of two or more thereof.

4. The composition of claim 1 wherein the sulfur source is elemental sulfur.

5. The composition of claim 2 wherein the sulfur source is elemental sulfur.

6. The composition of claim 1 wherein the alkyl (meth)acrylate is n-butyl acrylate and the optional comonomer is glycidyl methacrylate.

7. The composition of claim 2 wherein the alkyl (meth)acrylate is n-butyl acrylate and the optional comonomer is glycidyl methacrylate.

8. The composition of claim 5 wherein the alkyl (meth)acrylate is n-butyl acrylate and the optional comonomer is glycidyl methacrylate.

9. The composition of claim 2 wherein the optional copolymer is styrene butadiene random copolymer, styrene-butadiene-styrene block copolymer, or combinations thereof.

10. The composition of claim 3 wherein the optional copolymer is styrene butadiene random copolymer, styrene-butadiene-styrene block copolymer, or combinations thereof.

11. The composition of claim 6 wherein the optional copolymer is styrene butadiene random copolymer, styrene-butadiene-styrene block copolymer, or combinations thereof.

12. The composition of claim 8 wherein the optional copolymer is styrene butadiene random copolymer, styrene-butadiene-styrene block copolymer, or combinations thereof.

13. A composition comprising or produced from asphalt; an ethylene copolymer comprising repeat units derived from ethylene, n-butyl acrylate, and glycidyl methacrylate; sulfur; and styrene butadiene random copolymer, styrene-butadiene-styrene block copolymer, or combinations thereof.

14. A process comprising contacting a sulfur source with a mixture, which comprises asphalt, an ethylene copolymer, and an optional copolymer wherein the sulfur source is elemental sulfur, a sulfur donor, a sulfur byproduct, or combinations of two or more thereof; the ethylene copolymer comprises units derived from ethylene, alkyl (meth)acrylate, and an optional comonomer; the optional copolymer comprises repeat units derived from styrene and butadiene; and the optional comonomer is carbon monoxide, glycidyl acrylate, glycidyl methacrylate, and glycidyl vinyl ether, or combinations of two or more thereof.

15. The process according to claim 14 wherein the mixture comprises the optional copolymer and the ethylene copolymer comprises units derived from the optional comonomer.

16. The process according to claim 14 wherein the sulfur source is sulfur, sodium diethyldithiocarbamate, 2,2-dithiobis(benzothiazole), mercaptobenzothiazole, dipentamethylenethiuram tetrasulfide, a sulfonic acid, a sulfide, a sulfoxide, a sulfone, or combinations of two or more thereof.

17. The process according to claim 15 wherein the sulfur source is sulfur.

18. A road pavement or roofing sheet comprising a composition wherein the composition comprises or is produced from asphalt, an ethylene copolymer, a sulfur source, and an optional copolymer comprising repeat units derived from styrene and butadiene wherein the ethylene copolymer comprises units derived from ethylene, alkyl (meth)acrylate, and an optional comonomer; the sulfur source is elemental sulfur, a sulfur donor, a sulfur byproduct, or combinations of two or more thereof; the optional copolymer comprises repeat units derived from styrene and butadiene; and the optional comonomer is carbon monoxide, glycidyl acrylate, glycidyl methacrylate, and glycidyl vinyl ether, or combinations of two or more thereof.

19. The road pavement or roofing sheet of claim 18 wherein the ethylene copolymer comprises units derived from the optional comonomer; and the sulfur source is sulfur, sodium diethyldithiocarbamate, 2,2-dithiobis(benzothiazole), mercaptobenzothiazole, dipentamethylenethiuram tetrasulfide, a sulfonic acid, a sulfide, a sulfoxide, a sulfone, or combinations of two or more thereof.

20. The road pavement or roofing sheet of claim 19 wherein the sulfur source is sulfur.
